(19) United States
(12) Patent Application Publication
(10) Pub. No.: US 2004/0261161 A1
(43) Pub. Date: Dec. 30, 2004

(54) Rain and waterproof body suit having flotation capabilities

(76) Inventor: Robert Roy, St. Barnabe (CA)

Correspondence Address: INVENTARIUM, SUITE 1607, 4050, ROSEMONT BLVD, MONTREAL, QC, H1X2M4, CA

(21) Appl. No.: 10/872,017

(22) Filed: Jun. 18, 2004

Related U.S. Application Data
(60) Provisional application No. 60/480,674, filed on Jun. 24, 2003.

(51) Int. Cl. G21F 3/02

(52) U.S. Cl. 2/456

(57) ABSTRACT

A waterproof body suit with an integrated hood,a nose and mouth shield, a torso portion defined at its bottom by a belt, legs portion terminating as integrated socks and being covered with booties having soles, a pair of standard sleeves and a second pair of sleeves terminating with integrated mittens.

### BACKGROUND OF THE INVENTION

1. Field of the Invention

The invention relates generally to protective clothings but more particularly to a suit offering versatility by being wearable as a simple lightweight rainsuit as well as being usable as a flotation device especially useful for fishermen or even hunters.

2. Background of the Invention

Several waterproof suits or rain suits have been invented over the years and they can roughly be divided in two categories: Waterproof suits used to protect against rain or against any types of environment where water sprinkling occurs and waterborne suits for immersion such as emergency suits used as flotation device by use of inflatable bladders.

### SUMMARY OF THE INVENTION

It is a first object of this invention to provide for a suit that is usable as a rainsuit.

It is a second object of this invention to provide for a suit that is usable as a waterproof immersion suit.

It is a final object of this invention to provide for a suit that is usable as a flotation device.

In order to do so, the present invention involves a suit using a thin lightweight waterproof fabric and a unique set of two pairs of sleeves with one pair offering an open end to expose the hands while the other pair is terminated by integrated mittens, thus eliminating any infiltration of water at the wrists. For the legs, they are also sealed at the bottom, ending up somewhat like socks and being covered by tied up booties with soles. The suit is itself a one piece jumpsuit with a sealed front zipper, an adjustable band around the waist and user inflatable bladders to provide floatability to the suit.

The foregoing and other objects, features, and advantages of this invention will become more readily apparent from the following detailed description of a preferred embodiment with reference to the accompanying drawings, wherein the preferred embodiment of the invention is shown and described, by way of examples. As will be realized, the invention is capable of other and different embodiments, and its several details are capable of modifications in various obvious respects, all without departing from the invention. Accordingly, the drawings and description are to be regarded as illustrative in nature, and not as restrictive.

### BRIEF DESCRIPTION OF THE PREFERRED EMBODIMENT

FIG. 1 Full suit.

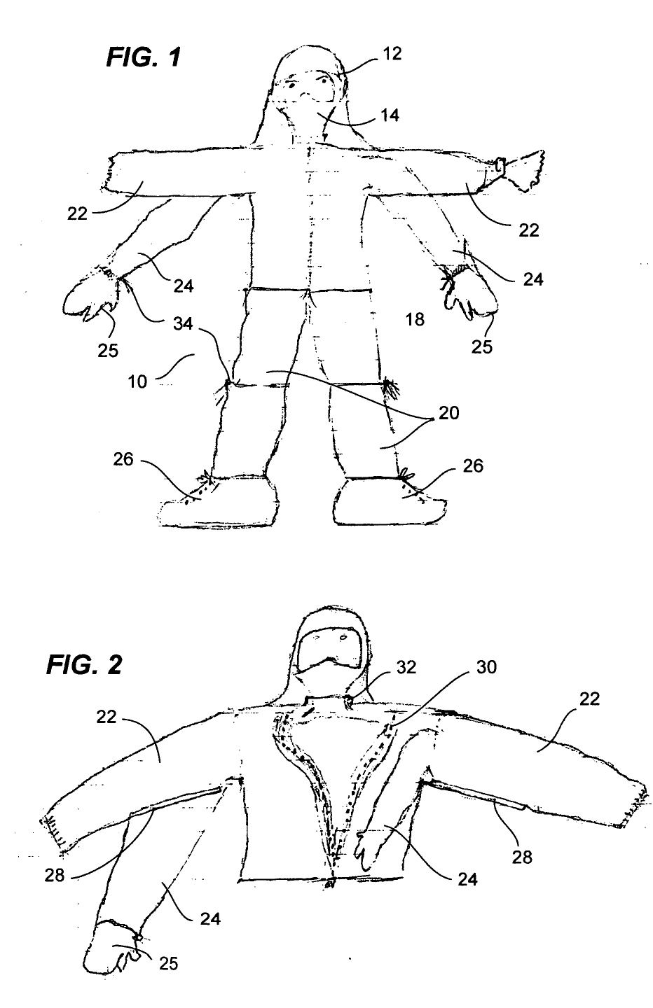

FIG. 2 Top part with a sleeve inside.

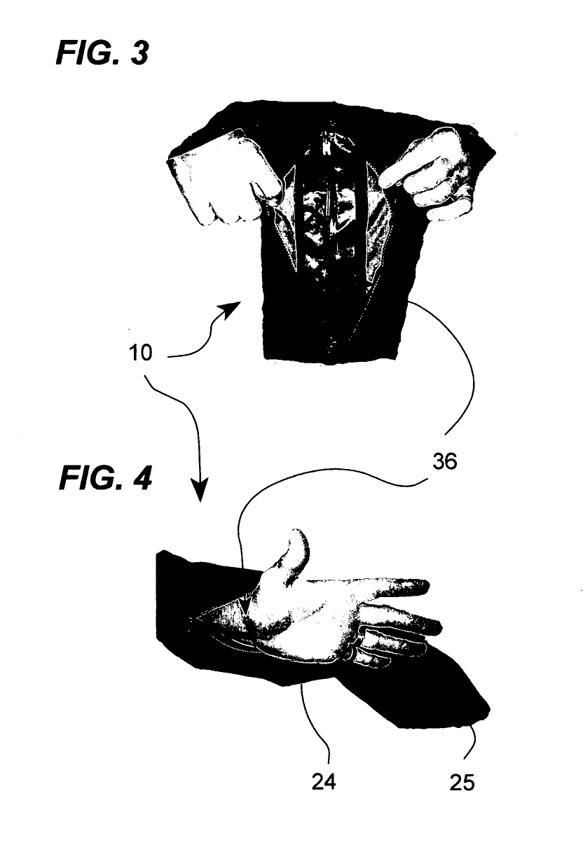

FIG. 3 Photograph showing zippered access to pant pockets.

FIG. 4 Photograph showing zippered means for allowing hands to come out of suit.

### DETAILED DESCRIPTION OF THE PREFERRED EMBODIMENT

Referring to FIG. 1, the waterproof body suit (10) is a one piece suit having an integrated hood (12) with a nose and mouth shield (14), a torso portion (16) defined at its bottom by a belt (18), legs portion (20), standard sleeves (22) and watertight sleeves (24) which terminate with integrated mittens (25). The term mittens (25) defined here for describing gloves as well, whether 5 finger gloves or 3 finger gloves.

The legs portion (20) terminates as integrated socks that are covered with booties (26) preferably with soles. The booties (26) are secured to the legs portion (20) by lace or hook and pile or any such means.

FIG. 2 When there is a need for crossing a waterway, the user removes his arms from the standard sleeves (22), rolls them up and tucks them inside the suit (10). A variety of common means comprised of, but not limited to, elastic bands or hook and pile strips can be used for keeping the rolled up standard sleeve (22) rolled up. The watertight sleeves (24) are proximal the standard sleeves (22) and are usually drawn inside the suit (10) when not in use, much like the standard sleeve (22) so they are out of the way. A watertight zipper (30) insures that water will not enter the suit (10) and a tight turtle neck (32) also insures reasonable watertight properties. The suit (10) is by no means a diving suit and is mostly for use in water from the neck down. The inflatability of the suit (10) insures that the neck always remains above the waterline. Inflating the suit (10) is accomplished by means well known in the art, generally blowing into a short tube and inflating one or more bladders. Tying means (34) situated approximately at knee height and at the wrist help control the flow of air so that when inflating the suit (10), air won't reach the hands, which would make it harder to use them and by not allowing air to go as far down the legs, less air is needed to inflate the suit (10) for adequate floatability. Tying means (34) are selected from the group comprised of but not limited to laces, drawstrings elastic bands, hook and pile.

Other features include watertight zippered accesses (36) inside the suit (10) at locations matching pant pockets so as to allow the wearer of the suit (10) an access to the contents of his clothes (see FIG. 3). Similar watertight zippered accesses (36) are located at the bottom of the watertight sleeves (24), just above said mittens (25), to allow hands to come out of the watertight sleeves (24) (see FIG. 4) .

1. A waterproof body suit with an integrated hood;
a nose and mouth shield;
a torso portion defined at its bottom by a belt;
legs portion terminating as integrated socks and being covered with booties having soles;
a pair of standard sleeves;
said waterproof body suit having the following improvement:
a second pair of sleeves terminating with integrated mittens.

2. A waterproof body suit as in claim 1 wherein: inflatable means to inflate said waterproof body suit.

3. A waterproof body suit as in claim 1 wherein:
watertight zippered accesses located at the bottom of said watertight sleeves, just above said mittens, to allow hands to come out of said watertight sleeves.
